(19) United States
(12) Patent Application Publication
(10) Pub. No.: US 2024/0275536 A1
(43) Pub. Date: Aug. 15, 2024

(54) FREQUENCY HOPPING FOR MULTIPLE UPLINK REPETITIONS

(71) Applicant: QUALCOMM Incorporated, San Diego, CA (US)

(72) Inventors: Shaozhen GUO, Beijing (CN); Mostafa KHOSHNEVISAN, San Diego, CA (US); Xiaoxia ZHANG, San Diego, CA (US); Jing SUN, San Diego, CA (US); Changlong XU, Beijing (CN); Yitao CHEN, San Marcos, CA (US)

(21) Appl. No.: 18/567,289

(22) PCT Filed: Aug. 20, 2021
(86) PCT No.: PCT/CN2021/113687

§ 371 Date: Dec. 5, 2023

(51) Int. Cl. H04L 5/00; H04L 1/08

(52) U.S. Cl. CPC H04L 5/0012; H04L 1/08

(57) ABSTRACT

Various aspects of the present disclosure generally relate to wireless communication. In some aspects, a user equipment (UE) may set, for frequency hopping of multiple physical uplink shared channel (PUSCH) repetitions of multiple transport blocks (TBs), a first frequency for a first frequency hop and a second frequency for a second frequency hop. The UE may transmit the PUSCH repetitions with frequency hopping such that the PUSCH repetitions alternate between the first frequency hop and the second frequency hop. Numerous other aspects are described.

### FIELD OF THE DISCLOSURE

Aspects of the present disclosure generally relate to wireless communication and to techniques and apparatuses for frequency hopping for multiple physical uplink channel repetitions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include setting, for frequency hopping of multiple physical uplink shared channel (PUSCH) repetitions of multiple transport blocks (TBs), a first frequency for a first frequency hop and a second frequency for a second frequency hop. The method may include transmitting the PUSCH repetitions with frequency hopping such that the PUSCH repetitions alternate between the first frequency hop and the second frequency hop.

Some aspects described herein relate to a method of wireless communication performed by a base station. The method may include setting, for frequency hopping of multiple PUSCH repetitions of multiple TBs transmitted from a UE, a first frequency for a first frequency hop and a second frequency for a second frequency hop. The method may include receiving the PUSCH repetitions with frequency hopping such that the PUSCH repetitions alternate between the first frequency hop and the second frequency hop.

Some aspects described herein relate to a UE for wireless communication. The user equipment may include a memory and one or more processors coupled to the memory. The one or more processors may be configured to set, for frequency hopping of multiple PUSCH repetitions of multiple TBs, a first frequency for a first frequency hop and a second frequency for a second frequency hop. The one or more processors may be configured to transmit the PUSCH repetitions with frequency hopping such that the PUSCH repetitions alternate between the first frequency hop and the second frequency hop.

Some aspects described herein relate to a base station for wireless communication. The base station may include a memory and one or more processors coupled to the memory. The one or more processors may be configured to set, for frequency hopping of multiple PUSCH repetitions of multiple TBs transmitted from a UE, a first frequency for a first frequency hop and a second frequency for a second frequency hop. The one or more processors may be configured to receive the PUSCH repetitions with frequency hopping such that the PUSCH repetitions alternate between the first frequency hop and the second frequency hop.

Some aspects described herein relate to a non-transitory computer-readable medium that stores a set of instructions for wireless communication by a UE. The set of instructions, when executed by one or more processors of the UE, may cause the UE to set, for frequency hopping of multiple PUSCH repetitions of multiple TBs, a first frequency for a first frequency hop and a second frequency for a second frequency hop. The set of instructions, when executed by one or more processors of the UE, may cause the UE to transmit the PUSCH repetitions with frequency hopping such that the PUSCH repetitions alternate between the first frequency hop and the second frequency hop.

Some aspects described herein relate to a non-transitory computer-readable medium that stores a set of instructions for wireless communication by a base station. The set of instructions, when executed by one or more processors of the base station, may cause the base station to set, for frequency hopping of multiple PUSCH repetitions of multiple TBs transmitted from a UE, a first frequency for a first frequency hop and a second frequency for a second frequency hop. The set of instructions, when executed by one or more processors of the base station, may cause the base station to receive the PUSCH repetitions with frequency hopping such that the PUSCH repetitions alternate between the first frequency hop and the second frequency hop.

Some aspects described herein relate to an apparatus for wireless communication. The apparatus may include means for setting, for frequency hopping of multiple PUSCH repetitions of multiple TBs, a first frequency for a first frequency hop and a second frequency for a second frequency hop. The apparatus may include means for transmitting the PUSCH repetitions with frequency hopping such that the PUSCH repetitions alternate between the first frequency hop and the second frequency hop.

Some aspects described herein relate to an apparatus for wireless communication. The apparatus may include means for setting, for frequency hopping of multiple PUSCH repetitions of multiple TBs transmitted from a UE, a first frequency for a first frequency hop and a second frequency for a second frequency hop. The apparatus may include means for receiving the PUSCH repetitions with frequency hopping such that the PUSCH repetitions alternate between the first frequency hop and the second frequency hop.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a single downlink control information (DCI) scheduling multiple physical uplink channel communications, in accordance with the present disclosure.

FIG. 4 is a diagram illustrating examples of frequency hopping for physical uplink shared channel (PUSCH) repetition Type A, in accordance with the present disclosure.

FIG. 5 is a diagram illustrating examples of frequency hopping for PUSCH repetition Type B, in accordance with the present disclosure.

FIG. 6 is a diagram illustrating an example of inter-repetition frequency hopping, in accordance with the present disclosure.

FIG. 7 is a diagram illustrating an example of frequency hopping for multiple PUSCH repetitions for multiple transport blocks (TBs), in accordance with the present disclosure.

FIG. 8 is a diagram illustrating another example of frequency hopping for multiple PUSCH repetitions for multiple TBs, in accordance with the present disclosure.

FIG. 9 is a diagram illustrating another example of frequency hopping for multiple PUSCH repetitions for multiple TBs, in accordance with the present disclosure.

FIG. 10 is a diagram illustrating an example of frequency hopping for multiple transmit receive points, in accordance with the present disclosure.

FIG. 11 is a diagram illustrating an example process performed, for example, by a UE, in accordance with the present disclosure.

FIG. 12 is a diagram illustrating an example process performed, for example, by a base station, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

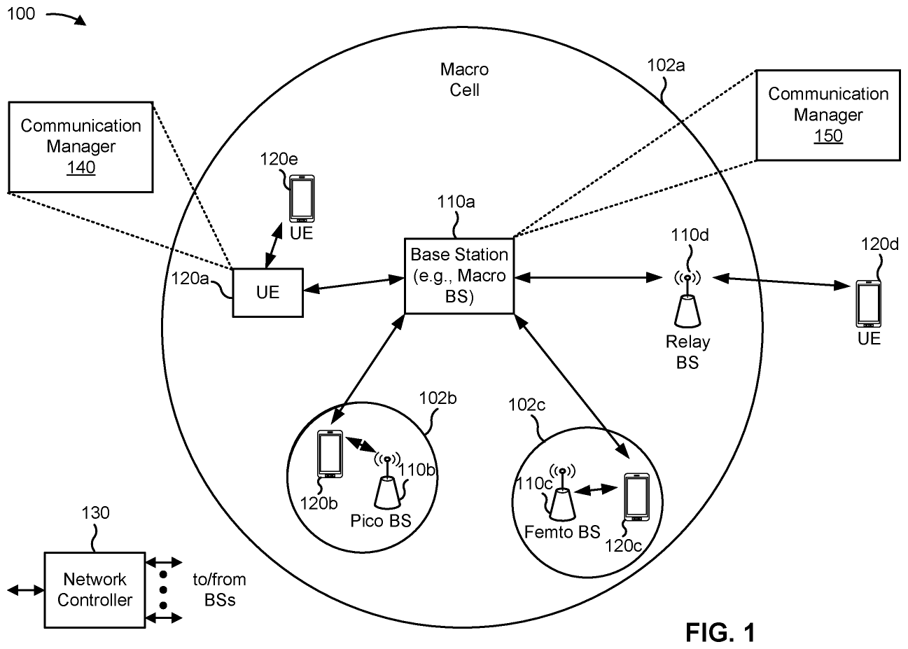

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V21) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may set, for frequency hopping of multiple physical uplink shared channel (PUSCH) repetitions of multiple transport blocks (TBs), a first frequency for a first frequency hop and a second frequency for a second frequency hop. The communication manager 140 may transmit the PUSCH repetitions with frequency hopping such that the PUSCH repetitions alternate between the first frequency hop and the second frequency hop. Additionally, or alternatively, the communication manager 140 may perform one or more other operations described herein.

In some aspects, the base station 110 may include a communication manager 150. As described in more detail elsewhere herein, the communication manager 150 may set, for frequency hopping of multiple PUSCH repetitions of multiple TBs transmitted from a UE, a first frequency for a first frequency hop and a second frequency for a second frequency hop. The communication manager 150 may receive the PUSCH repetitions with frequency hopping such that the PUSCH repetitions alternate between the first frequency hop and the second frequency hop. Additionally, or alternatively, the communication manager 150 may perform one or more other operations described herein.

As indicated above, FIG. 1 is provided as an example. Other examples may differ from what is described with regard to FIG. 1.

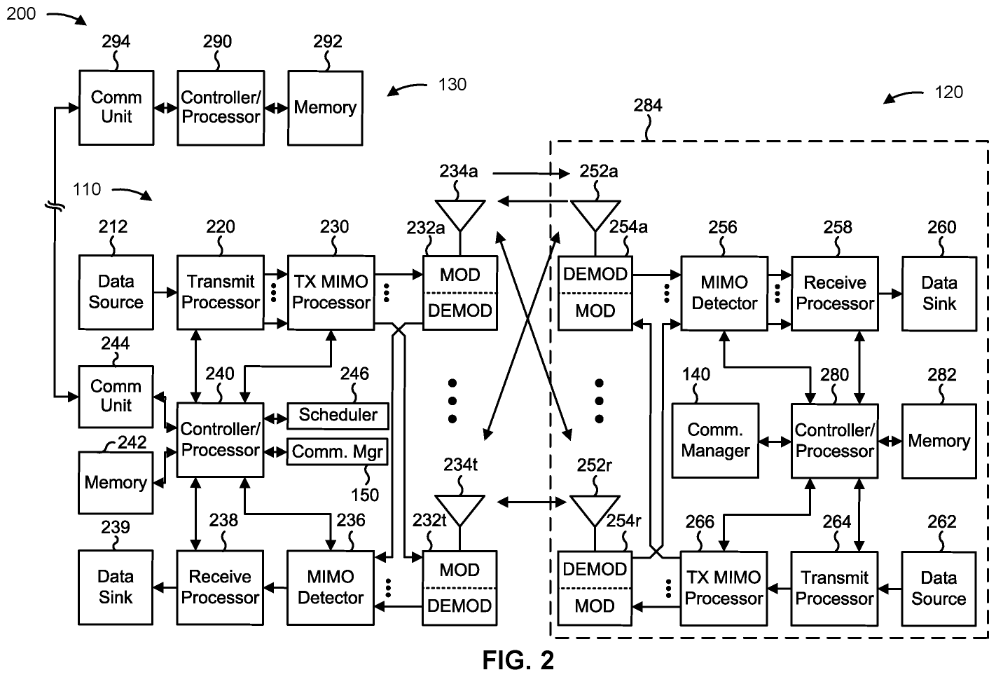

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

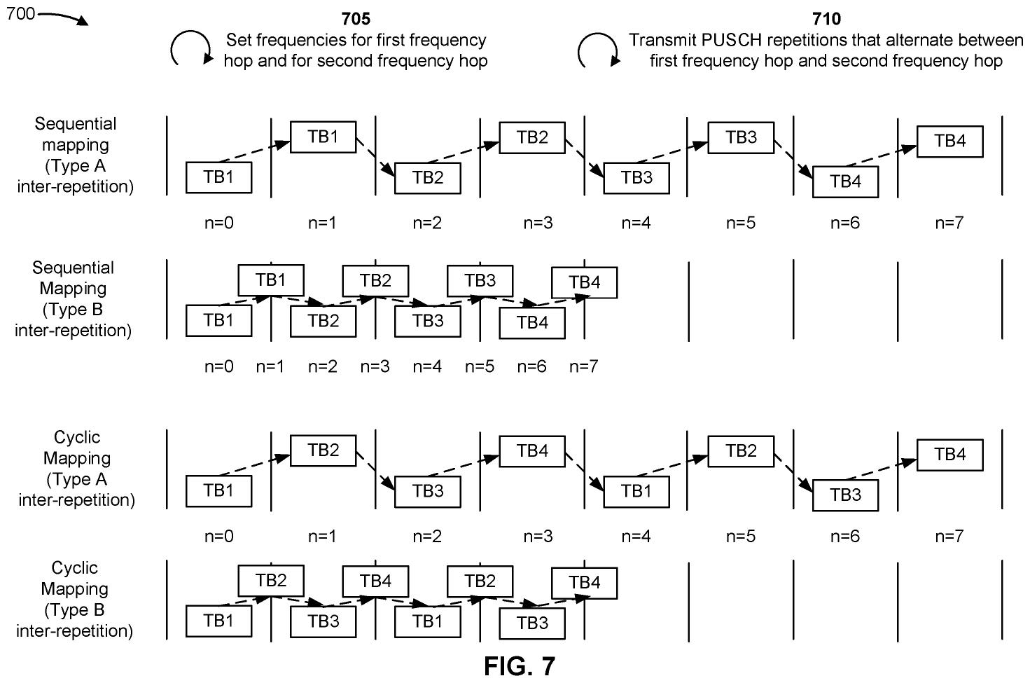

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-14).

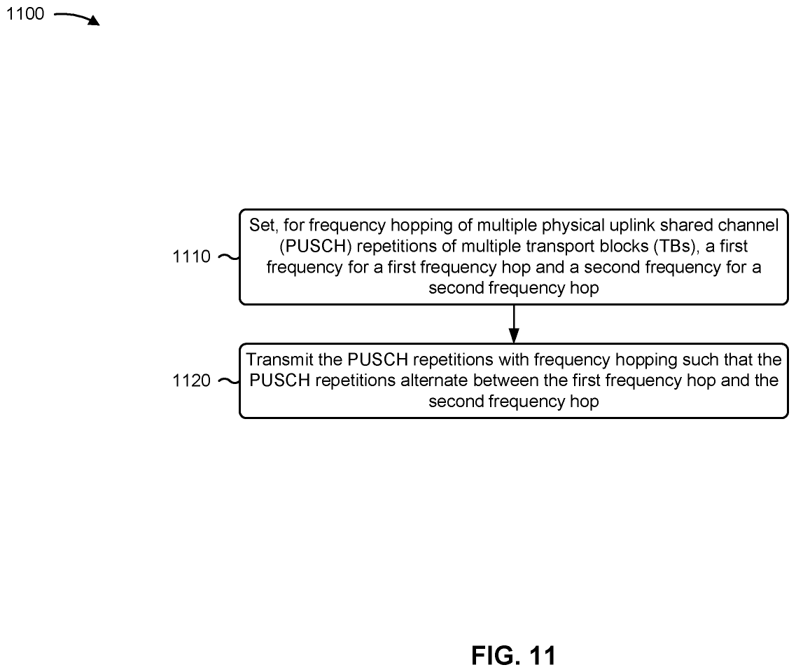

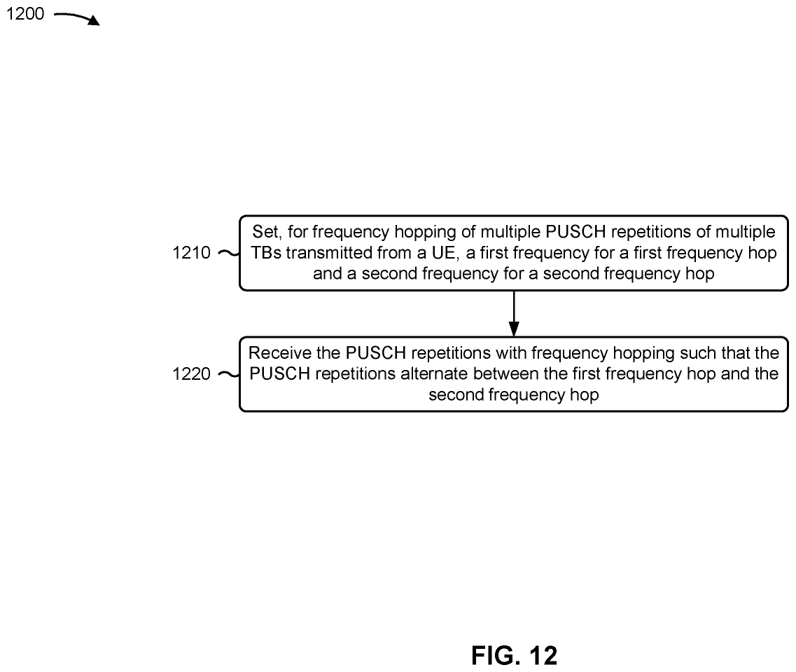

The controller/processor 240 of the base station 110, the controller/processor 280 of the UE 120, and/or any other component(s) of FIG. 2 may perform one or more techniques associated with frequency hopping for multiple PUSCH repetitions for multiple TBs, as described in more detail elsewhere herein. For example, the controller/processor 240 of the base station 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for setting, for frequency hopping of multiple PUSCH repetitions of multiple TBs, a first frequency for a first frequency hop and a second frequency for a second frequency hop; and/or means for transmitting the PUSCH repetitions with frequency hopping such that the PUSCH repetitions alternate between the first frequency hop and the second frequency hop. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for setting, for frequency hopping of multiple PUSCH repetitions of multiple TBs transmitted from a UE, a first frequency for a first frequency hop and a second frequency for a second frequency hop; and/or means for receiving the PUSCH repetitions with frequency hopping such that the PUSCH repetitions alternate between the first frequency hop and the second frequency hop. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

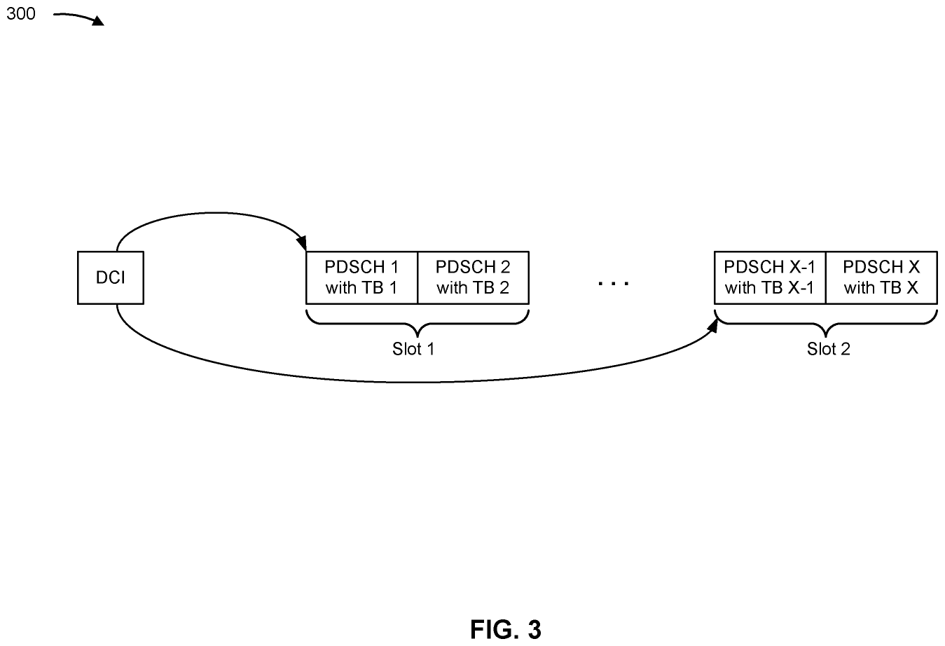

FIG. 3 is a diagram illustrating an example 300 of a single downlink control information (DCI) scheduling multiple physical uplink channel communications, in accordance with the present disclosure.

In higher frequency bands for NR, such as FR2 or higher, a single DCI is able to schedule multiple physical downlink shared channels (PDSCHs) or multiple PUSCHs with different TBs, as shown by example 300. Each PDSCH or PUSCH may have its own TB and duration, confined within a slot. Each TB may have its own hybrid automatic repeat request (HARQ) process identifier (ID), redundancy version ID (RVID), new data indicator (NDI), time domain resource allocation (TDRA), and/or frequency domain resource allocation (FDRA).

As indicated above, FIG. 3 is provided as an example. Other examples may differ from what is described with regard to FIG. 3.

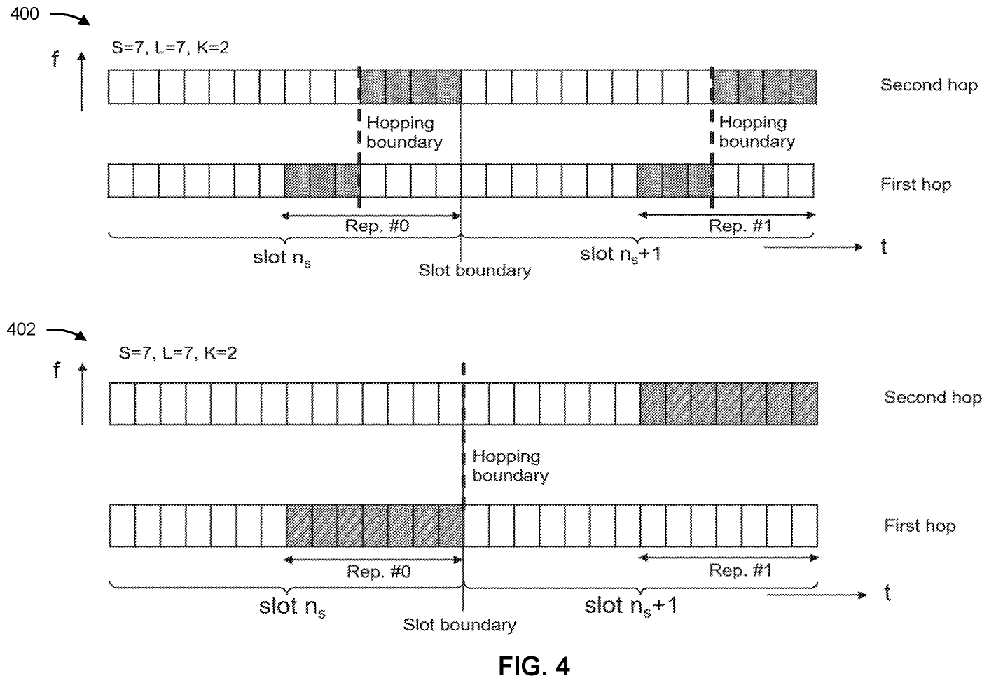

FIG. 4 is a diagram illustrating examples 400 and 402 of frequency hopping for PUSCH repetition Type A, in accordance with the present disclosure.

In some scenarios, a TB can be repeated over multiple slots (or mini-slots). PUSCH repetition includes repetition of a TB on a PUSCH. For PUSCH repetition Type A, a UE may be configured for frequency hopping by a higher layer parameter (e.g., frequencyHoppinDCI-0-2 or frequencyHopping provided in pusch-Config, frequencyHopping provided in configuredGrantConfig). Two frequency hopping modes include intra-slot frequency hopping (applicable to single slot and multi-slot PUSCH transmission) and inter-slot frequency hopping (applicable to multi-slot PUSCH transmission).

Example 400 shows an example of intra-slot frequency hopping. RBₛₜₐᵣₜ may represent a starting resource block (RB) for a first hop (i=0) within an uplink bandwidth part (BWP). The starting RB for a second hop (i=1) may be (RBₛₜₐᵣₜ+RB_{offset}) mod N_{BWP}^{size}, where RB_{offset} may be a frequency offset between the two frequency hops. The quantity of symbols in the first hop may be given by N_{symb}^{PUSCH,s}/2, and the quantity of symbols in the second hop may be given by N_{symb}^{PUSCH,s}−(N_{symb}^{PUSCH,s}/2). N_{symb}^{PUSCH,s} may be the length of the PUSCH transmission in OFDM symbols in one slot. In example 400, the hopping boundary for a PUSCH repetition is within each slot.

Example 402 shows an example of inter-slot frequency hopping. The starting RB during slot nᵤ^{s} may be RBₛₜₐᵣₜ for nᵤ^{s} mod 2=0 and (RBₛₜₐᵣₜ+RB_{offset}) mod N_{BWP}^{size} for nᵤ^{s} mod 2=1, where nᵤ^{s} is the current slot number within a radio frame. In example 402, the hopping boundary for a PUSCH repetition is at a slot boundary.

As indicated above, FIG. 4 provides some examples. Other examples may differ from what is described with regard to FIG. 4.

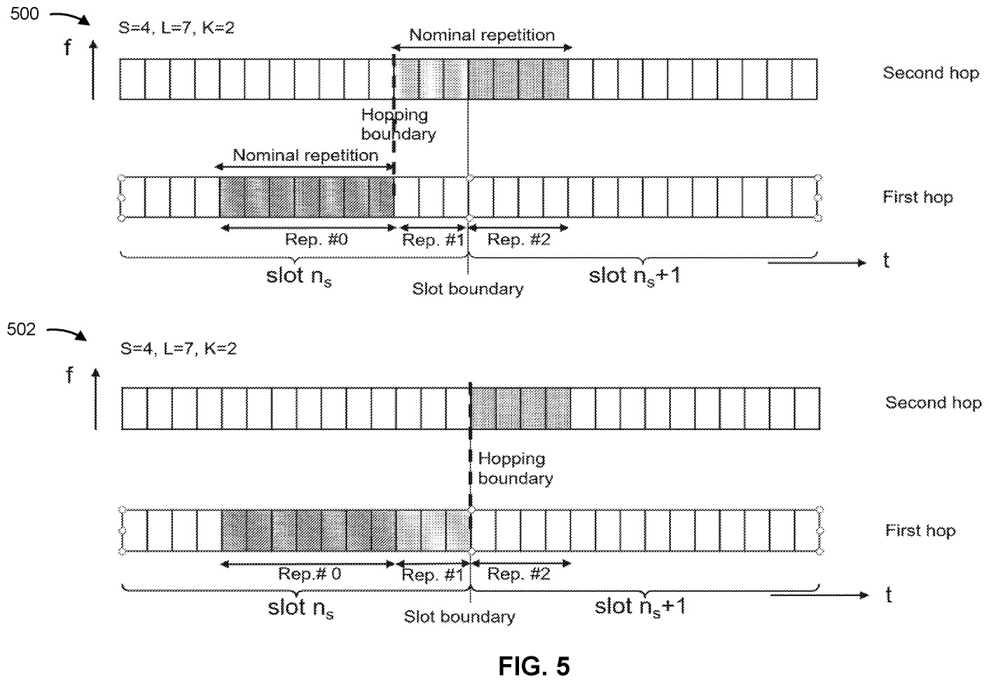

FIG. 5 is a diagram illustrating examples 500 and 502 of frequency hopping for PUSCH repetition Type B, in accordance with the present disclosure.

For PUSCH repetition Type B, a UE may be configured for frequency hopping by a higher layer parameter (e.g., frequencyHoppinDCI-0-2 or frequencyHoppingDCI-0-1 provided in pusch-Config,frequencyHoppingPUSCH-RepTypeB provided in rrc-configuredUplinkGrant). Frequency hopping modes may include inter-repetition frequency hopping and inter-slot frequency hopping.

Example 500 shows an example of inter-repetition frequency hopping. The starting RB of a first frequency hop for an actual repetition within the nth nominal repetition may be represented by RBₛₜₐᵣₜ for n mod 2=0. The starting RB for the second frequency hop may be (RBₛₜₐᵣₜ+RB_{offset}) mod N_{BWP}^{size} for n mod 2=1. In example 500, the hopping boundary is between PUSCH repetitions. The hopping boundary may be within a slot. A nominal repetition may span a slot boundary while actual repetitions may be separated by the slot boundary.

Example 502 shows an example of inter-slot frequency hopping. RBₛₜₐᵣₜ during slot nᵤ^{s} may be RBₛₜₐᵣₜ for nᵤ^{s} mod 2=0 and (RBₛₜₐᵣₜ+RB_{offset}) mod N_{BWP}^{size} for nᵤ^{s} mod 2=1. In example 502, the hopping boundary for a PUSCH repetition is at a slot boundary. Actual repetitions may be separated by the slot boundary.

As indicated above, FIG. 5 provides some examples. Other examples may differ from what is described with regard to FIG. 5.

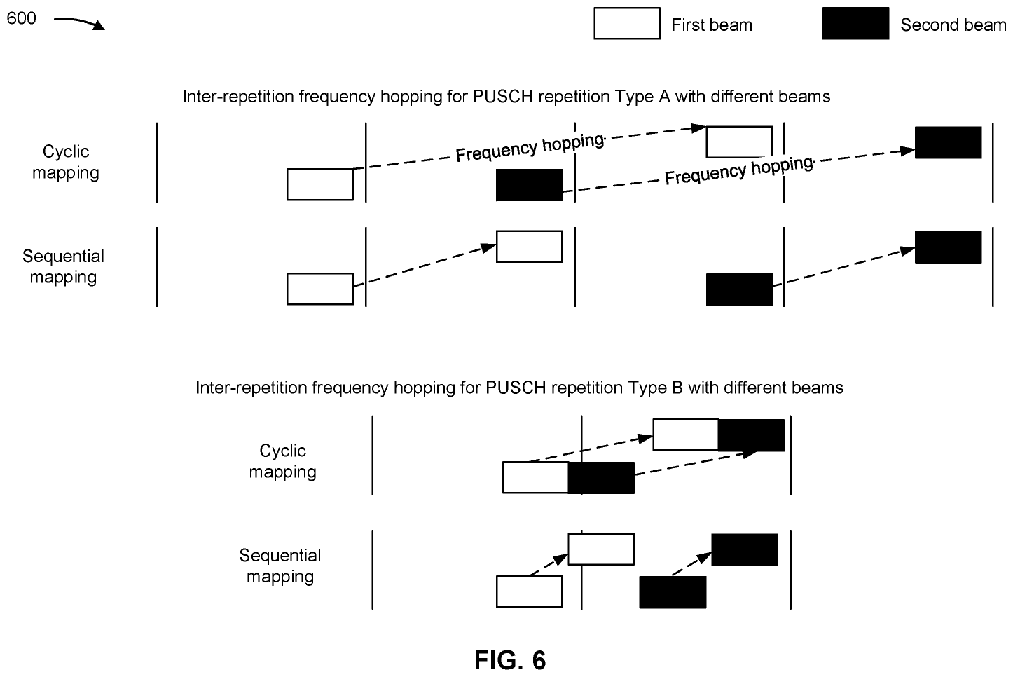

FIG. 6 is a diagram illustrating an example 600 of inter-repetition frequency hopping, in accordance with the present disclosure. Example 600 shows transmission of PUSCH repetitions on multiple beams (e.g., a first beam and a second beam). There may be multiple beams for multiple transmit receive points (TRPs).

Example 600 shows inter-repetition frequency hopping with PUSCH repetition Type A or Type B. A UE may perform inter-repetition frequency hopping for PUSCH repetitions of a TB within the same beam. Example 600 shows, for cyclic (interlaced) mapping where beams alternate or cycle in turn, frequency hopping is performed among repetitions of the first beam and frequency hopping is separately performed among repetitions of the second beam. For sequential mapping where repetitions for one beam occur sequentially before repetitions of another beam, frequency hopping is performed for repetitions of the first beam and then frequency hopping is separately performed for repetitions of the second beam.

As stated above, for higher frequency ranges of NR, a single DCI may schedule multiple TBs. However, it has not been specified how a UE is to handle inter-repetition frequency hopping and inter-PUSCH frequency hopping for multiple PUSCH repetitions of multiple TBs, including for multiple TRPs (multiple beams). For example, frequency hopping could be applied to all repetitions across all TBs or to all repetitions of the same TB. For multiple TRPs, frequency hopping could be applied to all repetitions across all TBs with the same beam or to all repetitions of the same TB with the same beam. If the UE is not properly configured to handle frequency hopping for multiple PUSCH repetitions of multiple TBs, frequency diversity may be reduced, and communications may degrade. Degraded communications may cause the UE to waste processing resources and signaling resources. Note that a UE configuration for frequency hopping may not need to change for intra-PUSCH frequency hopping, because frequency hopping is performed for each PUSCH irrespective of repetition and beam. No change may be required for inter-slot frequency hopping because frequency hopping is performed for different slots irrespective of repetition and beam.

As indicated above, FIG. 6 is provided as an example. Other examples may differ from what is described with regard to FIG. 6.

FIG. 7 is a diagram illustrating an example 700 of frequency hopping for multiple PUSCH repetitions for multiple TBs, in accordance with the present disclosure.

According to various aspects described herein, a UE (e.g., UE 120) may be configured to transmit multiple PUSCH repetitions for multiple TBs with frequency hopping such that the PUSCH repetitions alternate between frequency hops. The UE may be specifically configured to alternate frequency hops across all TBs (regardless of to which TB a PUSCH repetition belongs) or alternate frequency hops for the same TB (frequency hopping occurs for each TB individually). For multiple TRPs, the UE may be configured, for each beam, to alternate frequency hops across all TBs or for the same TB. As a result of the UE being properly configured for frequency hopping with multiple TBs, there will not be ambiguity between the UE and the base station as to which frequency hops are to be used for the multiple PUSCH repetitions of the multiple TBs.

Example 700 provides some examples of how the UE may be configured for inter-repetition frequency hopping for multiple TBs. The UE may prepare to transmit multiple PUSCH repetitions for multiple TBs according to a frequency hopping configuration. As shown by reference number 705, the UE may set frequencies for a first frequency hop and a second frequency hop. That is, the UE may specifically set a first frequency for the first frequency hop and a second frequency for the second frequency hop. The UE may determine which PUSCH repetitions for which TB are to be transmitted on the first frequency hop and on the second frequency hop. The UE may use a formula to determine a frequency hop for each PUSCH repetition of each TB.

As shown by reference number 710, the UE may transmit PUSCH repetitions for the TBs with the configured frequency hopping. The frequency hopping may alternate PUSCH repetitions for TBs between the first frequency hop and the second frequency hop. In some aspects, the UE may alternate PUSCH repetitions across all TBs, or without regard to which TB a PUSCH repetition belongs. For example, each PUSCH transmission occasion may be a PUSCH repetition of a given TB among the PUSCH repetitions for the TBs. Example 700 shows an nth PUSCH transmission occasion, where n starts at 0 and increments for each PUSCH transmission occasion up to N−1. N may represent a total number of PUSCH transmission occasions (e.g., for a specified time period or cycle). For sequential mapping with Type A inter-repetition, the UE alternates PUSCH repetitions in each slot such that a first transport block (TB1) has a first repetition (n=0) transmitted at the first frequency hop in a first slot and a second repetition (n=1) transmitted at the second frequency hop in a second slot. A second transport block (TB2) has a first repetition (n=2) transmitted at the first frequency hop in a third slot and a second repetition (n=3) transmitted at the second frequency hop in a fourth slot, and so forth for other TBs. For Type B inter-repetition, the TBs may span slot boundaries, and frequency hopping may be applied based at least in part on nominal repetitions. The base station may be aware of the frequency hopping pattern and may expect to receive the PUSCH repetitions for the TBs according to the configuration. This may involve setting the first frequency for the first frequency hop and the second frequency for the second frequency hop.

In some aspects, the UE may use a formula to achieve this type of frequency hopping. For example, the UE may apply the first frequency hop to an nth PUSCH transmission occasion if n modulo 2 is 0 (zero) and apply the second frequency hop to the nth PUSCH transmission occasion if n modulo 2 is 1 (one). That is, the UE may apply the first frequency hop to even PUSCH transmission occasions and the second frequency hop to odd PUSCH transmission occasions (or apply the first frequency hop to odd PUSCH transmission occasions and so forth). If there are more than two frequency hops, such as m frequency hops, the formula may involve n modulo m.

For cyclic mapping with Type A inter-repetition, the UE may alternate TBs in each slot such that a first transport block (TB1) has a first repetition (n=0) transmitted at the first frequency hop in a first slot and a second TB (TB2) has a first repetition (n=1) transmitted at the second frequency hop in a second slot. A third TB (TB3) has a first repetition (n=2) transmitted at the first frequency hop in a third slot and a fourth TB (TB4) has a first repetition (n=3) transmitted at the second frequency hop in a fourth slot. This repeats with a second repetition of each TB, starting in the fifth slot (n=4). For Type B inter-repetition, the TBs may span slot boundaries.

As indicated above, FIG. 7 is provided as an example. Other examples may differ from what is described with regard to FIG. 7.

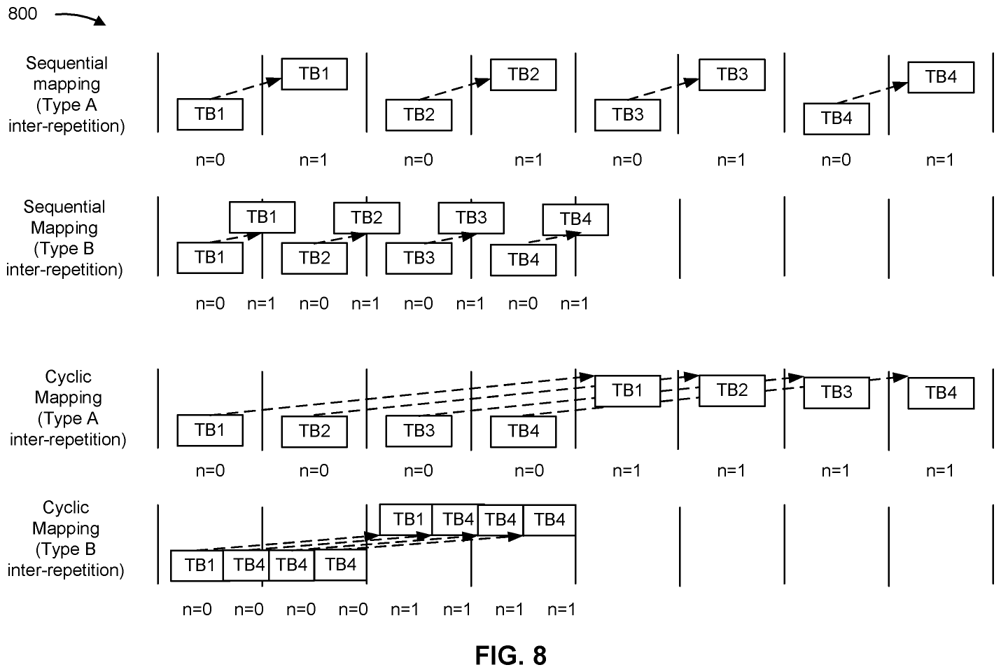

FIG. 8 is a diagram illustrating another example 800 of frequency hopping for multiple PUSCH repetitions for multiple TBs, in accordance with the present disclosure.

In some aspects, to increase frequency diversity, the UE may be configured to transmit PUSCH repetitions for TBs that alternate between frequency hops for the same TB rather than across all TBs. That is, the UE may be specifically configured to alternate frequency hops for TB1, separately alternate frequency hops for TB2, and so forth for the other TBs.

Example 800 shows an nth PUSCH transmission occasion, where n starts at 0 and increments for each PUSCH transmission occasion of the same TB. For another TB, n starts at 0 and increments for each PUSCH transmission occasion of that TB. For sequential mapping with Type A inter-repetition, the UE may alternate PUSCH repetitions in each slot such that a first transport block (TB1) has a first repetition (n=0) transmitted at the first frequency hop in a first slot and a second repetition (n=1) transmitted at the second frequency hop in a second slot. A second transport block (TB2) may have a first repetition (n=0) transmitted at the first frequency hop in a third slot and a second repetition (n=1) transmitted at the second frequency hop in a fourth slot, and so forth for other TBs. For Type B inter-repetition, the TBs may span slot boundaries, and frequency hopping may be applied based at least in part on nominal repetitions.

In some aspects, the UE may use a formula to achieve this type of frequency hopping. For example, there may be i TBs, each with multiple PUSCH repetitions. Each PUSCH repetition for each TB may be a single PUSCH transmission occasion. The UE may apply the first frequency hop to an nth PUSCH transmission occasion of an ith TB if n modulo 2 is 0 (zero) and apply the second frequency hop to the nth PUSCH transmission occasion of the ith TB if n modulo 2 is 1 (one). That is, the UE may apply the first frequency hop to even PUSCH transmission occasions of a TB and the second frequency hop to odd PUSCH transmission occasions of the same TB (or apply the first frequency hop to odd PUSCH transmission occasions and so forth). If there are more than two frequency hops, such as m frequency hops, the formula may involve n modulo m.

For cyclic mapping with Type A inter-repetition, the UE may alternate TBs in each slot such that a first transport block (TB1) has a first repetition (n=0) transmitted at the first frequency hop in a first slot and a second TB (TB2) has a first repetition (n=0) transmitted at the first frequency hop in a second slot. A third TB (TB3) has a first repetition (n=0) transmitted at the first frequency hop in a third slot and a fourth TB (TB4) has a first repetition (n=0) transmitted at the first frequency hop in a fourth slot. For a second repetition (n=1) of each TB, a first transport block (TB1) has a second repetition (n=1) transmitted at the second frequency hop in a fifth slot, and a second TB (TB2) has a second repetition (n=1) transmitted at the second frequency hop in a sixth slot. A third TB (TB3) has a second repetition (n=1) transmitted at the second frequency hop in a seventh slot, and a fourth TB (TB4) has a second repetition (n=1) transmitted at the second frequency hop in an eighth slot. For Type B inter-repetition, the TBs may span slot boundaries.

As indicated above, FIG. 8 is provided as an example. Other examples may differ from what is described with regard to FIG. 8.

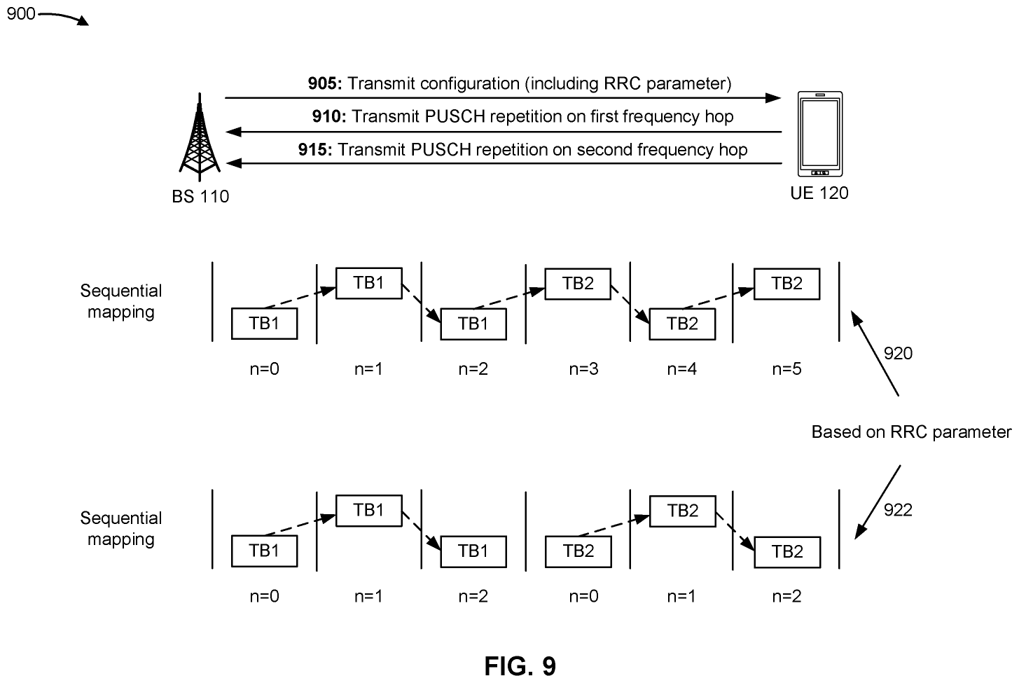

FIG. 9 is a diagram illustrating another example 900 of frequency hopping for multiple PUSCH repetitions for multiple TBs, in accordance with the present disclosure.

Example 900 shows how a base station (e.g., base station 110) may configure a UE (e.g., UE 120) with frequency hopping for multiple PUSCH repetitions for multiple TBs. As shown by reference number 905, the base station may transmit a configuration for frequency hopping to the UE. This may include an indication of a particular configuration (e.g., configuration index) or one or more parameters (e.g., radio resource control (RRC) parameters). One such parameter may indicate whether the UE is to use frequency hopping that alternates between a first frequency hop and a second frequency hop for PUSCH repetitions across all TBs (described in connection with FIG. 7) or alternates between a first frequency hop and a second frequency hop for PUSCH repetitions for the same TB (described in connection with FIG. 8).

As shown by reference number 910, the UE may transmit a first PUSCH repetition for a first TB (TB1) on a first frequency hop. As shown by reference number 915, the UE may transmit a second PUSCH repetition for TB1 on a second frequency hop. The UE may continue to alternate PUSCH repetitions for TBs between the first frequency hop and the second frequency hop, but how the UE continues to alternate transmissions may be based at least in part on a parameter indicated by the base station. For example, the UE may be configured to alternate PUSCH repetitions across all TBs, as shown by reference number 920. Example 900 shows that n increments for any TB, and n modulo 2=0 is for the first frequency hop and n modulo 2=1 is for the second frequency hop. The UE may use sequential mapping if configured to alternate across all TBs.

As shown by reference number 922, the UE may be configured to alternate between the first frequency hop and the second frequency hop for the same TB (for each TB). Example 900 shows that n increments only for the same TB, and n modulo 2=0 is for the first frequency hop and n modulo 2=1 is for the second frequency hop.

As indicated above, FIG. 9 is provided as an example. Other examples may differ from what is described with regard to FIG. 9.

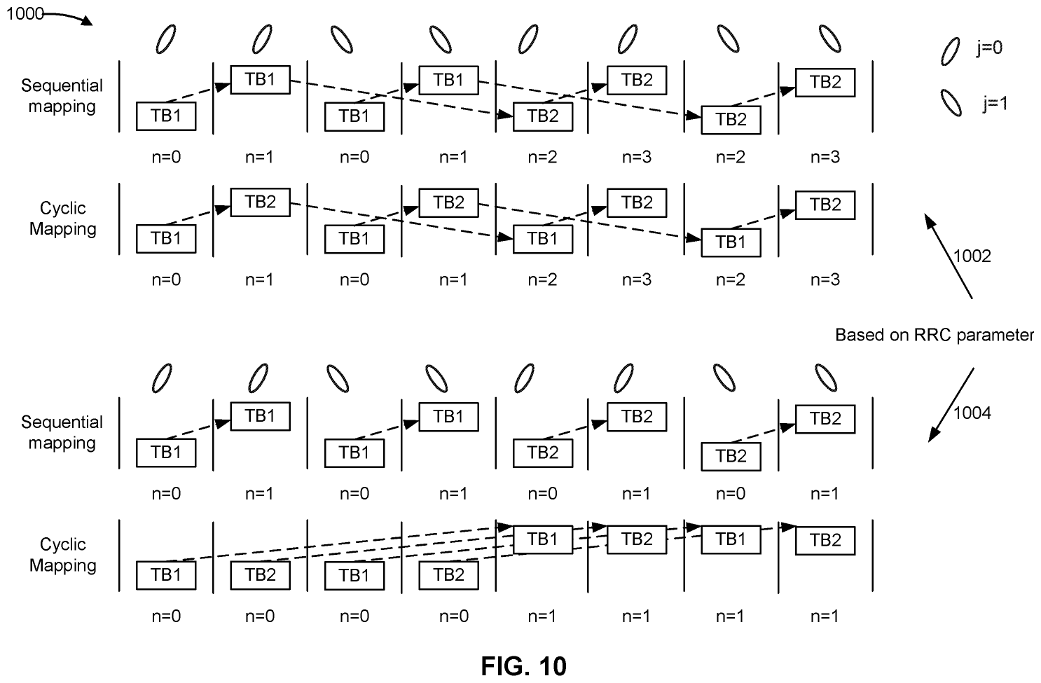

FIG. 10 is a diagram illustrating an example 1000 of frequency hopping for multiple TRPs, in accordance with the present disclosure. A UE (e.g., UE 120) may transmit multiple PUSCH repetitions for multiple TBs on multiple beams to multiple TRPs (or on multiple beams to a single TRP).

In some aspects, the UE may be configured to alternate between the first frequency hop and the second frequency hop further according to the beam, such as a first beam (j=0) or a second beam (=1). As shown by reference number 1002, the UE may alternate PUSCH repetitions across all TBs and for the same beam. Example 1000 shows an nth PUSCH transmission occasion, where n starts at 0 and increments for each PUSCH transmission occasion of a beam. For sequential mapping, the UE transmits PUSCH repetitions for TB1 at a first frequency hop (for n=0) and at a second frequency hop (for n=1) for the first beam (j=0). The UE then repeats this for the second beam (j=1). When the UE returns to the first beam, the UE transmits PUSCH repetitions for TB2 at the first frequency hop (for n=2) and at the second frequency hop (for n=3). In some aspects, the UE may use a formula to achieve this type of frequency hopping. For example, each PUSCH transmission occasion may be a PUSCH repetition of a given TB among the PUSCH repetitions for the TBs for a jth beam, where there are j different beams. The UE may apply the first frequency hop to an nth PUSCH transmission occasion of a jth beam if n modulo 2=0 and apply the second frequency hop to the nth PUSCH transmission occasion of the jth beam if n modulo 2=1. There may be up to Nⱼ−1 PUSCH transmission occasions, where Nⱼ is the total quantity of PUSCH transmission occasions across all TBs associated with the jth beam. If there are more than two frequency hops, such as m frequency hops, the formula may involve n modulo m. The UE may use sequential mapping if configured to alternate across all TBs.

For cyclic mapping, the UE may alternate TBs in each slot such that TB1 has a first repetition (n=0) transmitted at the first frequency hop for the first beam and TB2 has a first repetition (n=1) transmitted at the second frequency hop for the first beam. This repeats for the second beam. When the UE returns to the first beam, the UE transmits another repetition for TB1 at the first frequency hop (for n=2) and another repetition for TB2 at the second frequency hop (for n=3).

As shown by reference number 1004, the parameter may indicate that PUSCH repetitions for the same beam are not across all TBs but are for the same TB. This may help to increase frequency diversity in the case of cyclic mapping. For this configuration, example 1000 shows that n increments for the same TB and for the same beam, and that n modulo 2=0 is for the first frequency hop and n modulo 2=1 is for the second frequency hop.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with frequency hopping for multiple PUSCH repetitions for multiple TBs.

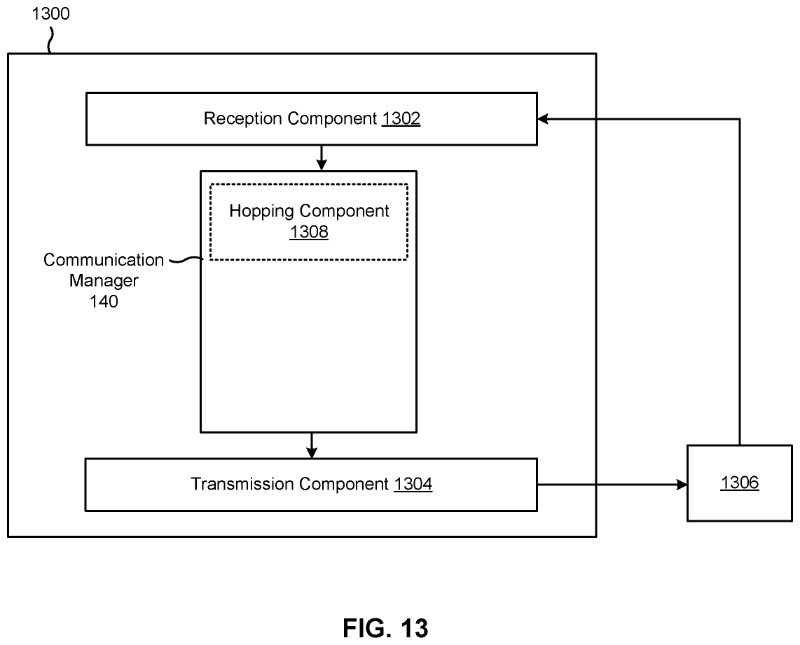

As shown in FIG. 11, in some aspects, process 1100 may include setting, for frequency hopping of multiple PUSCH repetitions of multiple TBs, a first frequency for a first frequency hop and a second frequency for a second frequency hop (block 1110). For example, the UE (e.g., using communication manager 140 and/or hopping component 1308 depicted in FIG. 13) may set, for frequency hopping of multiple PUSCH repetitions of multiple TBs, a first frequency for a first frequency hop and a second frequency for a second frequency hop, as described above in connection with FIGS. 7, 8, 9 and 10.

As further shown in FIG. 11, in some aspects, process 1100 may include transmitting the PUSCH repetitions with frequency hopping such that the PUSCH repetitions alternate between the first frequency hop and the second frequency hop (block 1120). For example, the UE (e.g., using communication manager 140 and/or transmission component 1304 depicted in FIG. 13) may transmit the PUSCH repetitions with frequency hopping such that the PUSCH repetitions alternate between the first frequency hop and the second frequency hop, as described above in connection with FIGS. 7, 8, 9 and 10.

Process 1100 may include additional aspects, such as any single aspect or any combination of aspects described below and/or in connection with one or more other processes described elsewhere herein.

In a first aspect, transmitting the PUSCH repetitions with frequency hopping includes applying the frequency hopping such that the first frequency hop is applied to an nth PUSCH transmission occasion if n modulo 2 is 0 (zero) and the second frequency hop is applied to the nth PUSCH transmission occasion if n modulo 2 is 1 (one), where each PUSCH transmission occasion is a PUSCH repetition of a given TB among the multiple PUSCH repetitions for the multiple TBs.

In a second aspect, alone or in combination with the first aspect, the first frequency hop and the second frequency hop alternate for each slot.

In a third aspect, alone or in combination with one or more of the first and second aspects, the first frequency hop and the second frequency hop alternate for each mini-slot.

In a fourth aspect, alone or in combination with one or more of the first through third aspects, transmitting the PUSCH repetitions with frequency hopping includes applying the frequency hopping such that PUSCH repetitions of a same TB alternate between the first frequency hop and the second frequency hop.

In a fifth aspect, alone or in combination with one or more of the first through fourth aspects, process 1100 includes receiving an indication of whether the frequency hopping is to be applied to the PUSCH repetitions without regard to TB or to be applied to PUSCH repetitions of a same TB, wherein transmitting the PUSCH repetitions with frequency hopping includes applying the frequency hopping based at least in part on the indication.

In a sixth aspect, alone or in combination with one or more of the first through fifth aspects, the indication is a radio resource control (RRC) parameter.

In a seventh aspect, alone or in combination with one or more of the first through sixth aspects, transmitting the PUSCH repetitions with the frequency hopping includes applying the frequency hopping such that PUSCH repetitions for a same beam and across the multiple TBs alternate between the first frequency hop and the second frequency hop.

In an eighth aspect, alone or in combination with one or more of the first through seventh aspects, transmitting the PUSCH repetitions with the frequency hopping includes applying the frequency hopping such that PUSCH repetitions for a same beam and for a same TB alternate between the first frequency hop and the second frequency hop.

In a ninth aspect, alone or in combination with one or more of the first through eighth aspects, process 1100 includes receiving an indication of whether the frequency hopping is to be applied to PUSCH repetitions for a same beam without regard to TB or for a same TB, and applying the frequency hopping includes applying the frequency hopping based at least in part on the indication.

In a tenth aspect, alone or in combination with one or more of the first through ninth aspects, the indication is an RRC parameter.

In an eleventh aspect, alone or in combination with one or more of the first through tenth aspects, process 1100 includes sequentially mapping the multiple PUSCH repetitions according to TB.

In a twelfth aspect, alone or in combination with one or more of the first through eleventh aspects, process 1100 includes cyclic mapping the multiple PUSCH repetitions of the multiple TBs or interlacing the multiple PUSCH repetitions of the multiple TBs.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with frequency hopping for multiple PUSCH repetitions of multiple TBs.

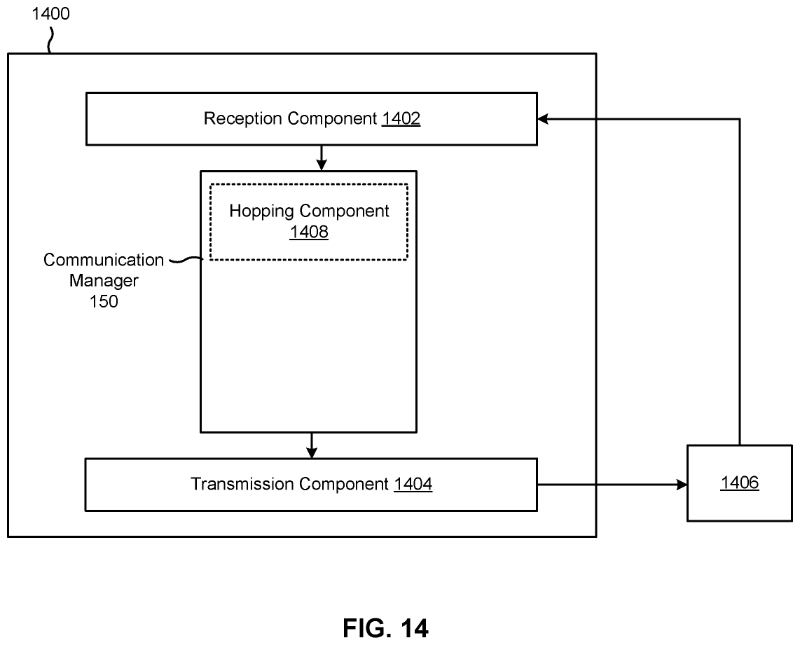

As shown in FIG. 12, in some aspects, process 1200 may include setting, for frequency hopping of multiple PUSCH repetitions of multiple TBs transmitted from a UE, a first frequency for a first frequency hop and a second frequency for a second frequency hop (block 1210). For example, the base station (e.g., using communication manager 150 and/or hopping component 1408 depicted in FIG. 14) may set, for frequency hopping of multiple PUSCH repetitions of multiple TBs transmitted from a UE, a first frequency for a first frequency hop and a second frequency for a second frequency hop, as described above in connection with FIGS. 7, 8, 9 and 10.

As further shown in FIG. 12, in some aspects, process 1200 may include receiving the PUSCH repetitions with frequency hopping such that the PUSCH repetitions alternate between the first frequency hop and the second frequency hop (block 1220). For example, the base station (e.g., using communication manager 150 and/or reception component 1402 depicted in FIG. 14) may receive the PUSCH repetitions with frequency hopping such that the PUSCH repetitions alternate between the first frequency hop and the second frequency hop, as described above in connection with FIGS. 7, 8, 9 and 10.

Process 1200 may include additional aspects, such as any single aspect or any combination of aspects described below and/or in connection with one or more other processes described elsewhere herein.

In a first aspect, the first frequency hop is applied for an nth PUSCH transmission occasion if n modulo 2 is 0 (zero) and the second frequency hop is applied for the nth PUSCH transmission occasion if n modulo 2 is 1 (one), where each PUSCH transmission occasion is a PUSCH repetition of a given TB among the multiple PUSCH repetitions for the multiple TBs.

In a second aspect, alone or in combination with the first aspect, the first frequency hop and the second frequency hop alternate for each slot.

In a third aspect, alone or in combination with one or more of the first and second aspects, the first frequency hop and the second frequency hop alternate for each mini-slot.

In a fourth aspect, alone or in combination with one or more of the first through third aspects, PUSCH repetitions of a same TB alternate between the first frequency hop and the second frequency hop.

In a fifth aspect, alone or in combination with one or more of the first through fourth aspects, process 1200 includes transmitting, to the UE, an indication of whether the frequency hopping is to be applied to the PUSCH repetitions without regard to TB or to be applied to PUSCH repetitions of a same TB.

In a sixth aspect, alone or in combination with one or more of the first through fifth aspects, the indication is an RRC parameter.

In a seventh aspect, alone or in combination with one or more of the first through sixth aspects, PUSCH repetitions for a same beam and across the multiple TBs alternate between the first frequency hop and the second frequency hop.

In an eighth aspect, alone or in combination with one or more of the first through seventh aspects, PUSCH repetitions for a same beam and for a same TB alternate between the first frequency hop and the second frequency hop.

In a ninth aspect, alone or in combination with one or more of the first through eighth aspects, process 1200 includes transmitting an indication of whether the frequency hopping is to be applied to PUSCH repetitions for a same beam without regard to TB or for a same TB.

In a tenth aspect, alone or in combination with one or more of the first through ninth aspects, the indication is a radio resource control (RRC) parameter.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE (e.g., UE 120), or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include a hopping component 1308, among other examples.

In some aspects, the apparatus 1300 may be configured to perform one or more operations described herein in connection with FIGS. 1-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The hopping component 1308 may set, for frequency hopping of multiple PUSCH repetitions of multiple TBs, a first frequency for a first frequency hop and a second frequency for a second frequency hop. The transmission component 1304 may transmit the PUSCH repetitions with frequency hopping such that the PUSCH repetitions alternate between the first frequency hop and the second frequency hop.

The reception component 1302 may receive an indication of whether the frequency hopping is to be applied to the PUSCH repetitions without regard to TB or to be applied to PUSCH repetitions of a same TB, wherein transmitting the PUSCH repetitions with frequency hopping includes applying the frequency hopping based at least in part on the indication.

The reception component 1302 may receive an indication of whether the frequency hopping is to be applied to PUSCH repetitions for a same beam without regard to TB or for a same TB, where applying the frequency hopping includes applying the frequency hopping based at least in part on the indication. The hopping component 1308 may sequentially map the multiple PUSCH repetitions according to TB.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be abase station (e.g., base station 110), or a base station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a hopping component 1408, among other examples.

In some aspects, the apparatus 1400 may be configured to perform one or more operations described herein in connection with FIGS. 1-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the base station described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the base station described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station described in connection with FIG. 2. In some aspects, the transmission component 1404 may be co-located with the reception component 1402 in a transceiver.

The hopping component 1408 may set, for frequency hopping of multiple PUSCH repetitions of multiple TBs transmitted from a UE, a first frequency for a first frequency hop and a second frequency for a second frequency hop. The reception component 1402 may receive the PUSCH repetitions with frequency hopping such that the PUSCH repetitions alternate between the first frequency hop and the second frequency hop.

The transmission component 1404 may transmit, to the UE, an indication of whether the frequency hopping is to be applied to the PUSCH repetitions without regard to TB or to be applied to PUSCH repetitions of a same TB. The transmission component 1404 may transmit an indication of whether the frequency hopping is to be applied to PUSCH repetitions for a same beam without regard to TB or for a same TB.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: setting, for frequency hopping of multiple physical uplink shared channel (PUSCH) repetitions of multiple transport blocks (TBs), a first frequency for a first frequency hop and a second frequency for a second frequency hop; and transmitting the PUSCH repetitions with frequency hopping such that the PUSCH repetitions alternate between the first frequency hop and the second frequency hop.

Aspect 2: The method of Aspect 1, wherein transmitting the PUSCH repetitions with frequency hopping includes applying the frequency hopping such that the first frequency hop is applied to an nth PUSCH transmission occasion if n modulo 2 is 0 (zero) and the second frequency hop is applied to the nth PUSCH transmission occasion if n modulo 2 is 1 (one), wherein each PUSCH transmission occasion is a PUSCH repetition of a given TB among the multiple PUSCH repetitions for the multiple TBs.

Aspect 3: The method of Aspect 1 or 2, wherein the first frequency hop and the second frequency hop alternate for each slot.

Aspect 4: The method of any of Aspects 1-3, wherein the first frequency hop and the second frequency hop alternate for each mini-slot.

Aspect 5: The method of any of Aspects 1-4, wherein transmitting the PUSCH repetitions with frequency hopping includes applying the frequency hopping such that PUSCH repetitions of a same TB alternate between the first frequency hop and the second frequency hop.

Aspect 6: The method of any of Aspects 1-4, further comprising receiving an indication of whether the frequency hopping is to be applied to the PUSCH repetitions without regard to TB or to be applied to PUSCH repetitions of a same TB, wherein transmitting the PUSCH repetitions with frequency hopping includes applying the frequency hopping based at least in part on the indication.

Aspect 7: The method of Aspect 6, wherein the indication is a radio resource control (RRC) parameter.

Aspect 8: The method of any of Aspects 1-4, wherein transmitting the PUSCH repetitions with the frequency hopping includes applying the frequency hopping such that PUSCH repetitions for a same beam and across the multiple TBs alternate between the first frequency hop and the second frequency hop.

Aspect 9: The method of any of Aspects 1-4, wherein transmitting the PUSCH repetitions with the frequency hopping includes applying the frequency hopping such that PUSCH repetitions for a same beam and for a same TB alternate between the first frequency hop and the second frequency hop.

Aspect 10: The method of any of Aspects 1-9, further comprising receiving an indication of whether the frequency hopping is to be applied to PUSCH repetitions for a same beam without regard to TB or for a same TB, wherein applying the frequency hopping includes applying the frequency hopping based at least in part on the indication.

Aspect 11: The method of Aspect 10, wherein the indication is a radio resource control (RRC) parameter.

Aspect 12: The method of any of Aspects 1-11, further comprising sequentially mapping the multiple PUSCH repetitions according to TB.

Aspect 13: The method of any of Aspects 1-11, further comprising cyclic mapping the multiple PUSCH repetitions of the multiple TBs or interlacing the multiple PUSCH repetitions of the multiple TBs.

Aspect 14: A method of wireless communication performed by abase station, comprising: setting, for frequency hopping of multiple physical uplink shared channel (PUSCH) repetitions of multiple transport blocks (TBs) transmitted from a user equipment (UE), a first frequency for a first frequency hop and a second frequency for a second frequency hop; and receiving the PUSCH repetitions with frequency hopping such that the PUSCH repetitions alternate between the first frequency hop and the second frequency hop.

Aspect 15: The method of Aspect 14, wherein the first frequency hop is applied for an nth PUSCH transmission occasion if n modulo 2 is 0 (zero) and the second frequency hop is applied for the nth PUSCH transmission occasion if n modulo 2 is 1 (one), wherein each PUSCH transmission occasion is a PUSCH repetition of a given TB among the multiple PUSCH repetitions for the multiple TBs.

Aspect 16: The method of Aspect 14 or 15, wherein the first frequency hop and the second frequency hop alternate for each slot.

Aspect 17: The method of any of Aspects 14-16, wherein the first frequency hop and the second frequency hop alternate for each mini-slot.

Aspect 18: The method of any of Aspects 14-17, wherein PUSCH repetitions of a same TB alternate between the first frequency hop and the second frequency hop.

Aspect 19: The method of any of Aspects 14-17, further comprising transmitting, to the UE, an indication of whether the frequency hopping is to be applied to the PUSCH repetitions without regard to TB or to be applied to PUSCH repetitions of a same TB.

Aspect 20: The method of Aspect 19, wherein the indication is a radio resource control (RRC) parameter.

Aspect 21: The method of any of Aspects 14-17, wherein PUSCH repetitions for a same beam and across the multiple TBs alternate between the first frequency hop and the second frequency hop.

Aspect 22: The method of any of Aspects 14-17, wherein PUSCH repetitions for a same beam and for a same TB alternate between the first frequency hop and the second frequency hop.

Aspect 23: The method of any of Aspects 14-22, further comprising transmitting an indication of whether the frequency hopping is to be applied to PUSCH repetitions for a same beam without regard to TB or for a same TB.

Aspect 24: The method of Aspect 23, wherein the indication is a radio resource control (RRC) parameter.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
set, for frequency hopping of multiple physical uplink shared channel (PUSCH) repetitions of multiple transport blocks (TBs), a first frequency for a first frequency hop and a second frequency for a second frequency hop; and
transmit the PUSCH repetitions with frequency hopping such that the PUSCH repetitions alternate between the first frequency hop and the second frequency hop.

2. The UE of claim 1, wherein the one or more processors, to transmit the PUSCH repetitions with frequency hopping, are configured to apply the frequency hopping such that the first frequency hop is applied to an nth PUSCH transmission occasion if n modulo 2 is 0 (zero) and the second frequency hop is applied to the nth PUSCH transmission occasion if n modulo 2 is 1 (one), and wherein each PUSCH transmission occasion is a PUSCH repetition of a given TB among the multiple PUSCH repetitions for the multiple TBs.

3. The UE of claim 1, wherein the first frequency hop and the second frequency hop alternate for each slot.

4. The UE of claim 1, wherein the first frequency hop and the second frequency hop alternate for each mini-slot.

5. The UE of claim 1, wherein the one or more processors, to transmit the PUSCH repetitions with frequency hopping, are configured to apply the frequency hopping such that PUSCH repetitions of a same TB alternate between the first frequency hop and the second frequency hop.

6. The UE of claim 1, wherein the one or more processors are configured to receive an indication of whether the frequency hopping is to be applied to the PUSCH repetitions without regard to TB or to be applied to PUSCH repetitions of a same TB, and wherein the one or more processors, to transmit the PUSCH repetitions with frequency hopping, are configured to apply the frequency hopping based at least in part on the indication.

7. The UE of claim 6, wherein the indication is a radio resource control (RRC) parameter.

8. The UE of claim 1, wherein the one or more processors, to transmit the PUSCH repetitions with the frequency hopping, are configured to apply the frequency hopping such that PUSCH repetitions for a same beam and across the multiple TBs alternate between the first frequency hop and the second frequency hop.

9. The UE of claim 1, wherein the one or more processors, to transmit the PUSCH repetitions with the frequency hopping, are configured to apply the frequency hopping such that PUSCH repetitions for a same beam and for a same TB alternate between the first frequency hop and the second frequency hop.

10. The UE of claim 1, wherein the one or more processors are configured to receive an indication of whether the frequency hopping is to be applied to PUSCH repetitions for a same beam without regard to TB or for a same TB, and wherein the one or more processors, to apply the frequency hopping, are configured to apply the frequency hopping based at least in part on the indication.

11. The UE of claim 10, wherein the indication is a radio resource control (RRC) parameter.

12. The UE of claim 1, wherein the one or more processors are configured to sequentially map the multiple PUSCH repetitions according to TB.

13. The UE of claim 1, wherein the one or more processors are configured to cyclic map the multiple PUSCH repetitions of the multiple TBs or interlace the multiple PUSCH repetitions of the multiple TBs.

14. A base station for wireless communication, comprising:
a memory; and
one or more processors, coupled to the memory, configured to:
set, for frequency hopping of multiple physical uplink shared channel (PUSCH) repetitions of multiple transport blocks (TBs) transmitted from a user equipment (UE), a first frequency for a first frequency hop and a second frequency for a second frequency hop; and
receive the PUSCH repetitions with frequency hopping such that the PUSCH repetitions alternate between the first frequency hop and the second frequency hop.

15. The base station of claim 14, wherein the first frequency hop is applied for an nth PUSCH transmission occasion if n modulo 2 is 0 (zero) and the second frequency hop is applied for the nth PUSCH transmission occasion if n modulo 2 is 1 (one), and wherein each PUSCH transmission occasion is a PUSCH repetition of a given TB among the multiple PUSCH repetitions for the multiple TBs.

16. The base station of claim 14, wherein the first frequency hop and the second frequency hop alternate for each slot.

17. The base station of claim 14, wherein the first frequency hop and the second frequency hop alternate for each mini-slot.

18. The base station of claim 14, wherein PUSCH repetitions of a same TB alternate between the first frequency hop and the second frequency hop.

19. Base station of claim 14, wherein the one or more processors are configured to transmit, to the UE, an indication of whether the frequency hopping is to be applied to the PUSCH repetitions without regard to TB or to be applied to PUSCH repetitions of a same TB.

20. The base station of claim 19, wherein the indication is a radio resource control (RRC) parameter.

21. The base station of claim 14, wherein PUSCH repetitions for a same beam and across the multiple TBs alternate between the first frequency hop and the second frequency hop.

22. The base station of claim 14, wherein PUSCH repetitions for a same beam and for a same TB alternate between the first frequency hop and the second frequency hop.

23. The base station of claim 14, wherein the one or more processors are configured to transmit an indication of whether the frequency hopping is to be applied to PUSCH repetitions for a same beam without regard to TB or for a same TB.

24. The base station of claim 23, wherein the indication is a radio resource control (RRC) parameter.

25. A method of wireless communication performed by a user equipment (UE), comprising:
setting, for frequency hopping of multiple physical uplink shared channel (PUSCH) repetitions of multiple transport blocks (TBs), a first frequency for a first frequency hop and a second frequency for a second frequency hop; and
transmitting the PUSCH repetitions with frequency hopping such that the PUSCH repetitions alternate between the first frequency hop and the second frequency hop.

26. The method of claim 25, wherein transmitting the PUSCH repetitions with frequency hopping includes applying the frequency hopping such that the first frequency hop is applied to an nth PUSCH transmission occasion if n modulo 2 is 0 (zero) and the second frequency hop is applied to the nth PUSCH transmission occasion if n modulo 2 is 1 (one), and wherein each PUSCH transmission occasion is a PUSCH repetition of a given TB among the multiple PUSCH repetitions for the multiple TBs.

27. The method of claim 25, wherein transmitting the PUSCH repetitions with frequency hopping includes applying the frequency hopping such that PUSCH repetitions of a same TB alternate between the first frequency hop and the second frequency hop.

28. The method of claim 25, further comprising receiving an indication of whether the frequency hopping is to be applied to the PUSCH repetitions without regard to TB or to be applied to PUSCH repetitions of a same TB, wherein transmitting the PUSCH repetitions with frequency hopping includes applying the frequency hopping based at least in part on the indication.

29. The method of claim 25, wherein transmitting the PUSCH repetitions with the frequency hopping includes applying the frequency hopping such that PUSCH repetitions for a same beam and across the multiple TBs alternate between the first frequency hop and the second frequency hop.

30. The method of claim 25, wherein transmitting the PUSCH repetitions with the frequency hopping includes applying the frequency hopping such that PUSCH repetitions for a same beam and for a same TB alternate between the first frequency hop and the second frequency hop.
